(19) United States
(12) Patent Application Publication
(10) Pub. No.: US 2003/0159373 A1
(43) Pub. Date: Aug. 28, 2003

(54) Hurricane/storm device for windows and doors

(76) Inventor: Shihwei Lien, Voorhees, NJ (US)

Correspondence Address: KENNETH P. GLYNN, ESQ., Glynn & Associates, P.C., 24 Mine Street, Flemington, NJ, 08822, US

(21) Appl. No.: 10/085,677

(22) Filed: Feb. 27, 2002

(51) Int. Cl. E06B 3/26; E06B 1/04; E04C 2/38

(52) U.S. Cl. 52/202; 52/213; 52/204.71; 52/799.1; 52/741.3

(57) ABSTRACT

The present invention relates to a protective device for openings in a structure, e.g., windows and doors, from storms and hurricanes. The present invention also relates to the aforesaid devices in combination with the frames of openings. The present invention device provides for removably installing protective boards in structural openings as needed, such as when tornadoes, high winds, extreme rain and snowstorms or hurricanes are threatening a building. These devices rely upon and include rotating U channels that receive the protective board, and are then shut and secured. After the threat has passed, the device is unsecured or unlatched, the board is removed from the U channels and may be stored remotely so as to not interfere with the function or view of the opening, window or door.

### BACKGROUND OF THE INVENTION

1. Field of the Invention

The present invention relates to a protective device for openings in a structure, e.g., windows and doors, from storms and hurricanes. The present invention, more specifically, relates to unique arrangements for removably installing protective boards in structural openings as needed, i.e., at times when storms or hurricane are threatening or imminent. These devices rely upon and include rotating U channels that receive the board, are then shut and secured. After the threat has passed, the device is unsecured or unlatched, the board is removed by being slid out of the U channels and may be stored remotely so as to not interfere with the function or view of the opening, window or door.

2. Information Disclosure Statement

Since the advent of living structures with door and window openings, we have striven to protect the insides from the elements, and some modern structures have steel blinds, functional shutters or other protection to rely upon in high wind weather. However, most homes, buildings and other structures do not have workable installed or readily available wind protection, especially in areas where high wind storms are infrequent or rare.

The following patents are representative of more recent innovations in window and door storm protection:

U.S. Pat. No. 6,205,713 describes a shutter for withstanding hurricane wind and pressures that have permanent hardware attached to a structure and a temporary shutter that can be stored until needed. Hardware consists of brackets mounted above or below a window and sliding latches at the edges of the window. Sliding latches have a key way for a carriage bolt to enter and attach. Brackets allow a shutter that has attached hinges to latch and pivot around a bridge. The shutter can be made from any material. Hinges are attached to shutter and are able to be latched and pivoted on the brackets mounted on the house. The shutter is swung over the window and locked down sliding latches and carriage bolts with wing nuts through holes in shutter.

U.S. Pat. No. 5,737,874 describes a shutter for withstanding hurricane wind forces that has an outer rectangular frame formed by four U-shaped channel members. An inner rectangular frame, also formed of four U-shaped blade channels, is mounted within the U-shaped channels of the outer frame. A plurality of Z-shaped blades extend horizontally between the vertical U-shaped inner blade channels and are secured in an angular position by fasteners. The blades each have a pair of horizontal end flanges which are secured at opposite ends to the inner frame, and have an intervening angled panel of reduced thickness to enable the blades to flex and absorb the wind forces. Longitudinal fins are formed on the inner frame channels and engage portions of the outer frame to radiate wind forces exerted on the blades to the outer frame. A pair of spring-biased plunger rods are mounted at the bottom ends of the outer frame for securing the shutter in a locked position. The shutter is assembled by fastening the blades at their ends to two spaced inner blade channels, sliding the inner frame members within the outer frame members, and then securing the outer frame members together by comer braces to trap the inner frame and blades therein.

U.S. Pat. No. 5,540,018 describes an integrated window construction system. The present invention provides an integrated window construction system for mounting both window units and hurricane shutters, comprising a header bracket which includes a window header bracket portion and an upper shutter bracket portion spacedly connected by an extended member; a sill bracket comprising a window sill bracket portion and a lower shutter bracket portion spacedly connected by an extended section; means for fastening the header bracket to a window header; means for fastening the sill bracket to a window sill; means for mounting the window unit between the header and sill brackets; and means for securing at least one hurricane shutter between the header and sill brackets.

Notwithstanding the prior art, the present invention device, which involves permanently attached, rotatable U channels with removable protective boards, is neither taught nor rendered obvious thereby.

### SUMMARY OF THE INVENTION

The present invention relates to a protective device for openings in a structure, e.g., windows and doors, from storms and hurricanes. The present invention also relates to the aforesaid devices in combination with the frames of said openings. An important and unique aspect of the present invention relates to removably installing protective boards in structural openings as needed, such as when tornadoes, high winds, extreme rain and snow storms or hurricanes are threatening the building. These devices rely upon and include rotating U channels that receive the board, are then shut and secured. After the threat has passed, the device is unsecured or unlatched, the board is removed by being slid out of the U channels and may be stored remotely so as to not interfere with the function or view of the opening, window or door.

The terms “structure” and “building” are used herein, interchangeably to mean any physical construction which is occupied or occupiable for some human function, and which have one or more windows and/or doorways or their equivalent. These terms should be construed broadly to include homes, offices, government and military facilities, schools, commercial facilities, and auxiliary structures, such as barns, storage buildings, etc. The term “opening” as used herein, refers to a door, window or equivalent, such as a hatchway, a skylight, or any other area in a building wall which would have been open when the wall was constructed. These openings may be passable or impassable, and may physically open or not. For example, a skylight might not open, but it is still an opening in the wall of the structure. The term “wall” as used herein, should be construed broadly as any major outer surface of a building, including vertical walls, horizontal walls, angled walls, roofs, and inner walls exposed to weather, e.g. an inner courtyard wall.

The present invention is a device for protecting windows, doors, and other openings in a building from high wind weather, which utilizes two opposite, typically parallel, U channels as the essential base structure. These U channels may be made of materials selected from the group consisting of wood, plastic, metal and combinations thereof

The U channels each have an attachment end and a securing end, and are adapted to be mounted opposite one another within a frame of a building opening, inverted relative to one another and adapted to slideably receive a protective board. There are two attachment components, one for each of the U channels. Each of the attachment components have two attachment means, one attachment means adapted for attachment to the attachment end of a U channel, the other attachment means adapted for attachment to the frame of a building opening. The attachment components enable rotation between a building opening and the U channel, and may accomplish this with rotation within itself, rotation between itself and the U channel, rotation between itself and the frame, or a combination of these.

When the present invention attachment components are each attached to a U channel and each are attached to a normal surface of a frame of a building opening so that the U channels are rotatable relative to the frame, are opposite one another and inverted relative to one another, a protective board may removably slide into the U channels, the unit may be closed (rotated toward the structure) and secured. The protective board is generally flat and may have a periphery to accommodate the opening for which it is intended. In many embodiments, it will have a rectangular shape. It is adapted to removably slide into the two U channels when they are attached to a normal surface of a frame of a building opening via two attachment components. The present invention also includes securing means for securing the securing ends of the U channels to a frame of a building. These securing means may be slotted brackets and a securing bar, or latches at the protective board and frame, or a swing or screw lock and U channel orifice, or any other functional securing means. For example, the securing means may include an orifice at the securing end of each of the U channels, and an anchoring member for passing through the orifice and for attachment to a frame. In some embodiments, the orifice has a non-circular configuration and an anchoring member is a rotatable latch. In other embodiments, the aforesaid orifice has a keyhole configuration. In yet some other embodiments, the orifice may be a cut out passing through at least two walls of the U channels.

The protective board may be formed of any strong, continuous sheet flat material, such as wood, metal, plastic and composite materials, or combinations thereof. The protective board is preferably a composite that includes a first sheet of a structural plastic material and a second sheet of a glass fiber material. A very much preferred composite has a first sheet of a structural plastic material sandwiched between two sheets of a woven glass fiber material which has been formed together under heat and pressure.

### BRIEF DESCRIPTION OF THE DRAWINGS

The present invention should be more fully understood when the specification herein is taken in conjunction with the drawings appended hereto wherein:

FIG. 1 shows a front view of a widow, frame and wall of a structure, and FIG. 2 shows a side cut view thereof,

FIGS. 3 and 4 show the same view but now including a pair of present invention U channels mounted within the frame of the window so as to be rotatable therein;

FIG. 5 shows an end view of the invention U channel and frame;

FIG. 6 shows the window and U channels shown in FIGS. 3 and 4, but swing outwardly, with a present invention protective board being slid therein;

FIG. 7 shows the FIG. 6 window, U channels and protective board in place and secured with security means;

FIG. 8 shows a front view of double set of present invention Pairs of U channels and protective board mounted in a single, wide window;

FIG. 9 shows one embodiment of a present invention protective board;

FIGS. 10 and 11 show different arrangements for securing means of present invention devices;

FIGS. 12 and 13 show side cut views of alternative embodiment U channel mountings swinging upwardly and downwardly, respectively;

FIGS. 14, 15 and 16 illustrate another present invention U channel and attachment embodiment; and,

FIG. 17 illustrates a present invention optional U channel stabilizer option.

### DETAILED DESCRIPTION OF THE PRESENT INVENTION

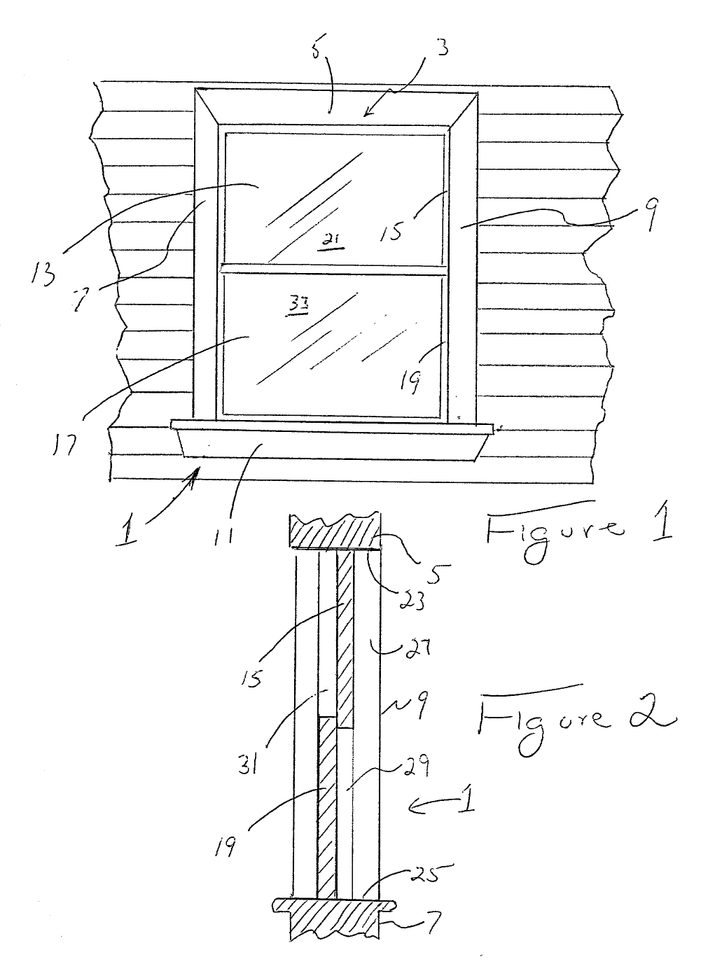

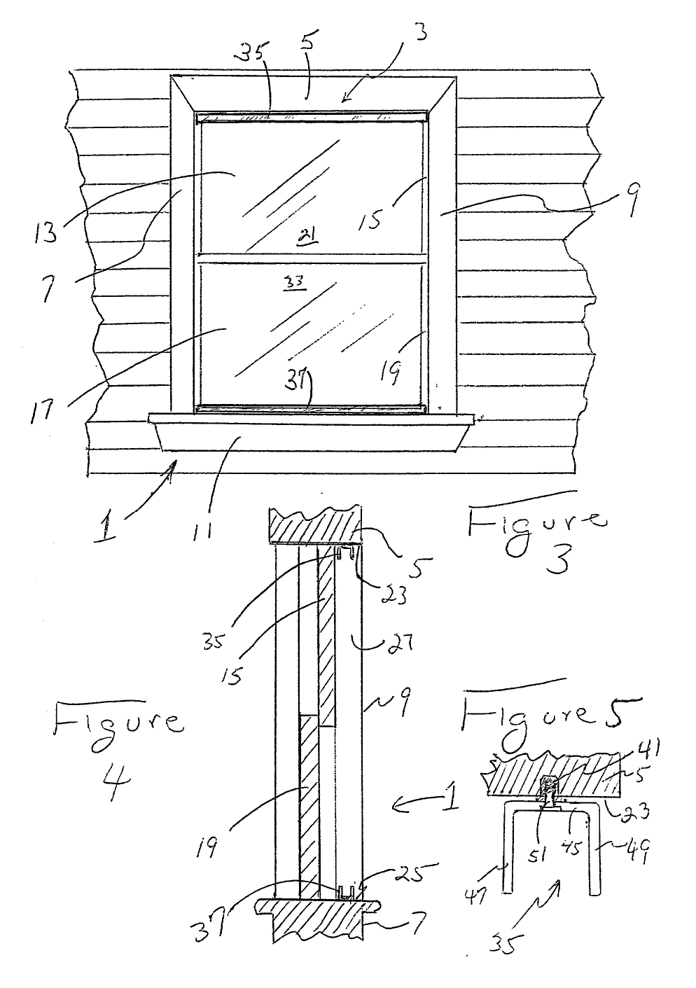

FIG. 1 shows a front view of a widow, frame and wall of a structure, and FIG. 2 shows a side cut view thereof. These Figures are presented to show a typical window arrangement with the U channels not yet mounted therein; FIGS. 3 and 4 show the same view but now including a pair of present invention U channels mounted within the frame of the window so as to be rotatable therein. Hence, with respect to these Figures, they will be discussed collectively, and identical elements are identically numbered. In these Figures, building wall 1 includes a window 3 is located therein, and window 3 includes two window sections 13 and 17, with solid inner frames 15 and 19 and glass panes 21 and 33 contained therein. These two window sections move up and down in vertical tracks, such as tracks 29 and 31.

Window 3 also includes a generally four part frame, made up of a top 5, left side 7, right side 9, and bottom 11. These four frame parts each include surfaces which are normal to the wall 1, i.e., surfaces that are approximately at right angles (out of) the wall 1. For example, top 5 has a normal surface 23, bottom 11 has a normal surface 25, and right side 9 has a normal surface 27. It is on the normal surface that the U channels are typically mounted in the present invention device.

As shown in FIGS. 3 and 4 specifically, U channels 35 and 37 are mounted at the top5 and bottom 11. FIG. 4 illustrates that these are mounted on normal surfaces 23 and 25. The U channels are shown as true U-shaped nut could be segmented or added to or modified without exceeding the present invention scope, as log as they are generally U-shaped or slotted to freely and removably receive the protective board. It is the concept of mounting the U channels permanently while freely removing the protective board to provide free use of the building opening that is one of the distinguishing features over the prior art devices.

FIG. 5 shows more detail of U channel 35 discussed above to illustrate the mounting details. U channel 35 has a base 45 and sidewalls 47 and 49. There is an orifice in base 45 for an attachment component with a first attachment means (in this case a flange or bolt head, with or without a washer) for the U channel 35 and a second attachment means (e.g., screw threading or sheathed lock bolt, or grommet 41 with the threaded bolt end) for the frame normal surface 23. This attachment component is to provide for rotation of the U channel relative to the window 3, and such may be accomplished by two rotating parts within the attachment component, by rotation between the attachment component and the frame, rotation between the attachment component and the U channel, or any combination of these.

FIG. 6 shows the window 3 and U channels 35 and 37 shown in FIGS. 3 and 4, but swung outwardly, with a present invention protective board 61 at corners 63 and 65 being freely and removably slid therein.

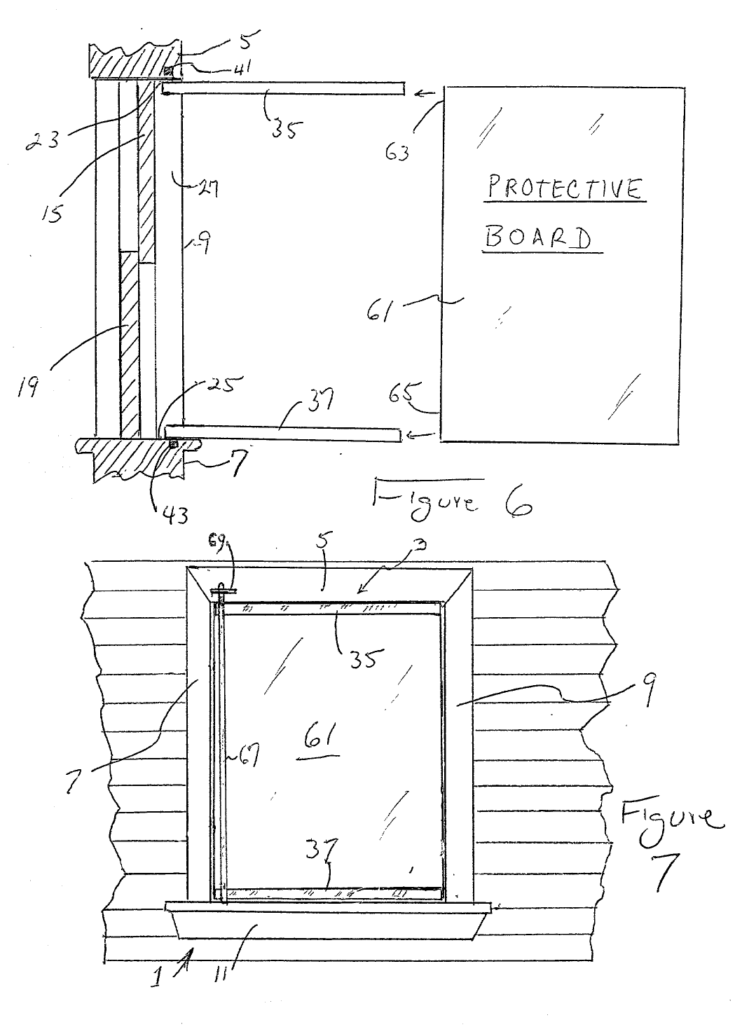

FIG. 7 shows the FIG. 6 wall, window 3, U channels 35 and 37 and protective board 61 in place and secured with securing means to hold the U channels 35 and 37, and protective board 61 in a secure, closed position for weather protection, as needed. In this case the securing means is a rod 67, an upper bracket 69 for receiving the removable rod 67, and a rod cup or hole in the sill of bottom 3, not shown. Alternatively, the securing means could be one or more latches, wing nuts and bolts, hooks loops, wires, rods, slats and brackets or any other securing means available. For example, any means used or known for securing a closed shutter could be used.

FIG. 8 shows a front view of double set of present invention Pairs of U channels and protective board mounted in a single, wide window;

FIG. 9 shows one embodiment of a present invention protective board 151 made of composite materials which includes a central plastic extruded board 155, preferably a fluted polypropylene board with linear or S shaped ribs, and outer layers 153 and 157, each initially made of interwoven glass fiber and polypropylene flexible yarn which has been sandwiched and annealed together through heat/pressure treatment.

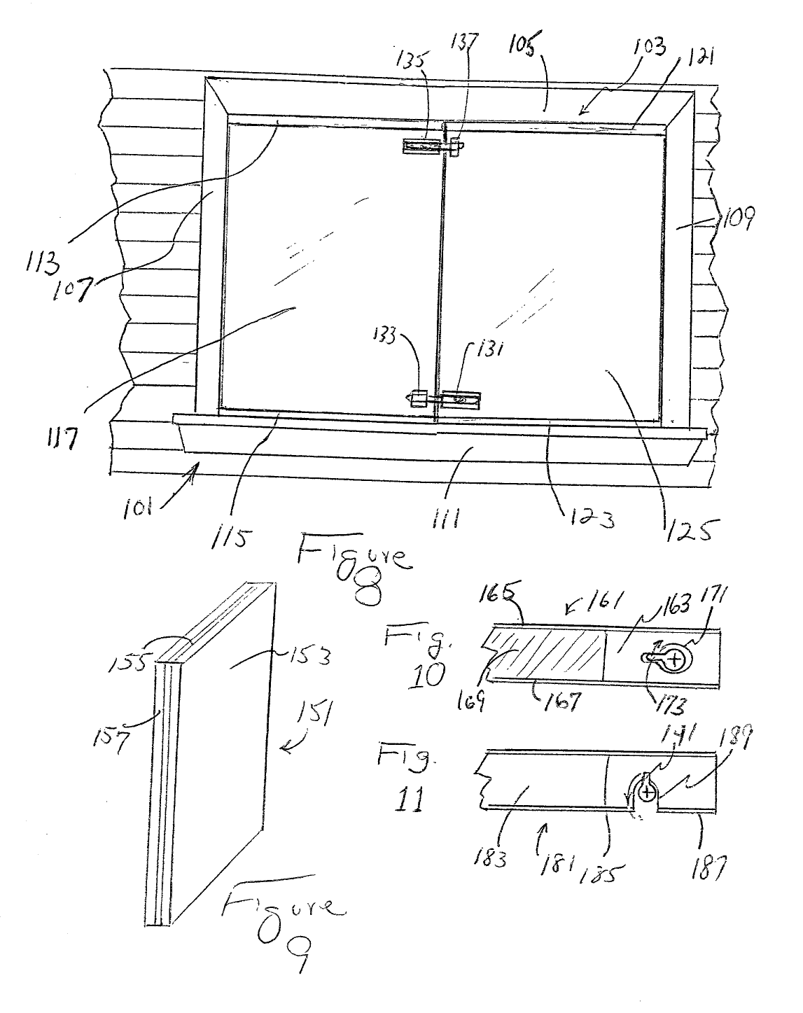

FIGS. 10 and 11 show different arrangements for securing means of present invention devices. In FIG. 10, there is a top view of a present invention U channel 161. it includes a base 163, and left and right walls 165 and 167. Base 163 has a keyhole type cut out 171. This enables base 163 to be moved over and onto screw key 171, which then may be rotated as shown by the arrow to securely hold the channel and a protective board 169 to its left, in place in a closed position. This keyhole 178 would be located on the U channel at an end opposite the end of the U channel where it is attached (attachment end) to the opening frame.

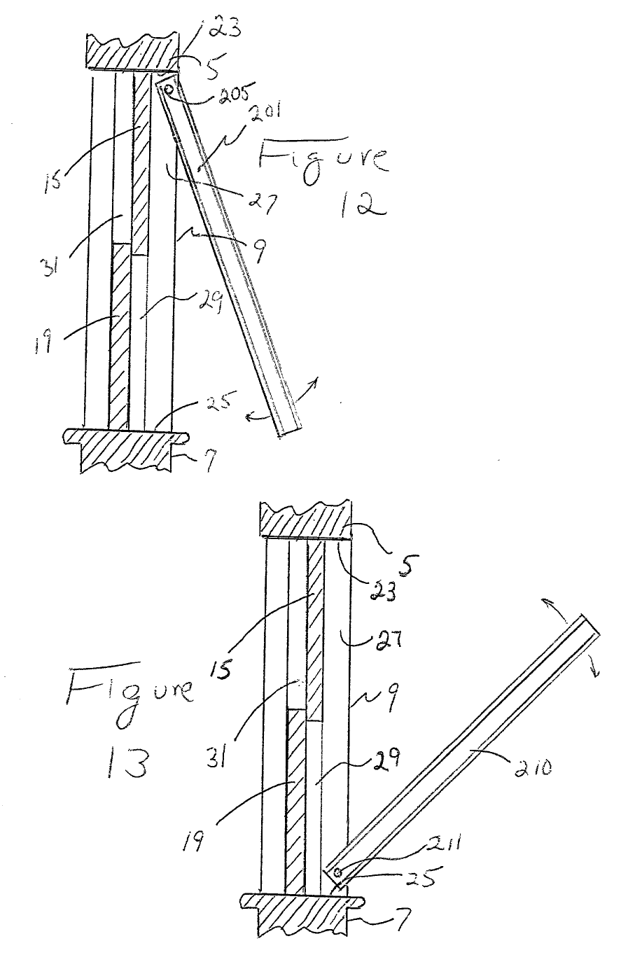

FIGS. 12 and 13 show side cut views of alternative embodiment U channel mountings swinging upwardly and downwardly, respectively, and all of the elements shown in FIG. 2 are shown here, and need not be repeated. In FIG. 12, U channel 201 is one of an oppositely positioned pair, and is mounted with attachment component 205 at the top area of sidewall normal surface 23 to swing outwardly and upwardly, as shown by the arrows. A protective board is slid up into the channel pair and the unit is swing closed and secured by any securing means described herein. Likewise, in FIG. 13, the U channel 210 is mounted in the same normal surface as in FIG. 12, except at the lower area so as to swing outwardly and downwardly, affording board insertion from the top, and otherwise closed and secured as taught herein.

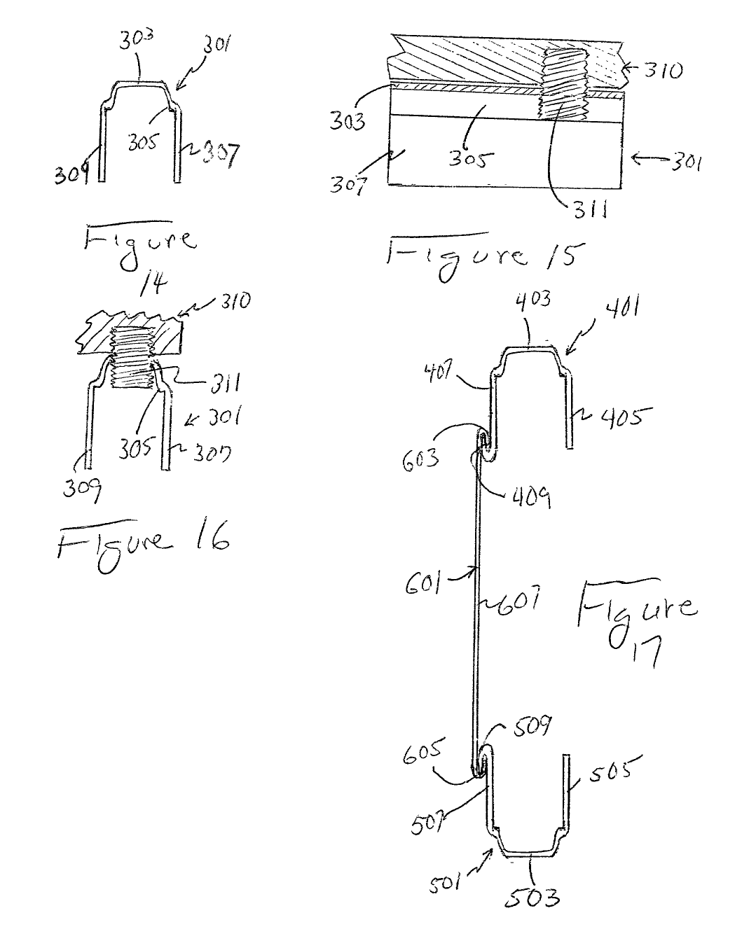

FIGS. 14, 15 and 16 show another present invention alternative embodiment U channel and attachment arrangement. Identical elements are identically numbered. Channel 301 includes a base 303 and sidewalls 309 and 307, and a ledge 305 on each side for supporting a protective board. This creates a recess for maintaining a hinge screw 311 (FIGS. 15 and 16) away from the protective board when it is inserted into the U channels. Thus, screw 311 is screwed into both the U channel 301 and the window or door frame 310 and acts both as a supporting member and a hinging member for opening and closing the U channel.

FIG. 17 shows an optional addition to the present invention to stabilize the U channels. Although this is not essential, it is useful for installations wherein the U channels may sag or vary in separation distance. Thus, U channels 401 and 501 each have a base 403 and 503, and sides 405 and 407, and 505, and 507, respectively and have a curled side edge 409 and 509 for snuggly fitting a spacer 601 therein. The spacer 601 has an elongated section 607 and hooked ends 603 and 605 for attachment to the U channels as described. This spacer may be an inch or so wide, but is approximately the protective board height, and maintains the U channels “square” and a fixed distance apart, for more easily receiving the protective board.

Obviously, numerous modifications and variations of the present invention are possible in light of the above teachings. It is therefore understood that within the scope of the appended claims, the invention may be practiced otherwise than as specifically described herein.

What is claimed is:

1. A device for protecting windows, doors, and other openings in a building from high wind weather, which comprises:
(a) two parallel U channels, each having an attachment end and a securing end, said U channels being adapted to be mounted opposite one another within a frame of a building opening, said U channels being adapted to slideably receive a protective board;
(b) two attachment components, each having two attachment means, one attachment means of each being adapted for attachment to the attachment end of said U channel, the other attachment means of each being adapted for attachment to a frame of a building opening, wherein, when said attachment components are each attached to a U channel and each are attached to a normal surface of a frame of a building opening so that said U channels are rotatable relative to said frame, are opposite one another and inverted relative to one another, so that a protective board may removably slide into said U channels;
(c) a protective board having a rectangular shape and adapted to removably slide into said two U channels when they are attached to a normal surface of a frame of a building opening via said two attachment components, so that said U channels are rotatable relative to said frame, are opposite one another and inverted relative to one another; and,
(d) securing means for temporarily securing said protective board and said U channels to a frame of a building to inhibit rotation of the U channels and protective board and to prevent removal of the protective board until unsecured.

2. The device of claim 1 wherein said U channels each contain an orifice at its attachment end for receiving an attachment component.

3. The device of claim 1 wherein said securing means includes an orifice at said securing end of each of said U channels and an anchoring member for passing through said orifice and for attachment to a frame.

4. The device of claim 3 wherein said orifice has a non-circular configuration and said anchoring member is a rotatable latch.

5. The device of claim 4 wherein said orifice has a keyhole configuration.

6. The device of claim 4 wherein said orifice is a cut out passing through at least two walls of said U channels.

7. The device of claim 1 wherein said protective board is a composite board which includes a first sheet of a structural plastic material and a second sheet of a glass fiber material.

8. The device of claim 7 wherein said composite board which includes a first sheet of a structural plastic material sandwiched between outer layers of fused polypropylene/glass fiber woven yarn.

9. The device of claim 1 wherein there are two sets of all elements set forth in claim 1, and they are adapted to be mounted adjacent one another as two sets of elements in a single opening of a building.

10. The device of claim 1 wherein said U channels are made of materials selected from the group consisting of plastic, metal and combinations thereof.

11. A storm protection device for protecting windows, doors, and other openings in a building from high wind weather, which comprises, in combination:
(a) a frame in an opening in a wall of a building, which frame includes at least two mounting members opposite one another, each having surfaces normal to said wall;
(b) two U channels, each having an attachment end and a securing end, said U channels being mounted opposite one another with attachment components to one of said frame mounting members on its surface normal to said wall of said building, said U channels being adapted to slideably receive a protective board;
(c) two attachment components, each having two attachment means, one attachment means of each being attached to the attachment end of said U channel, the other attachment means of each being attached to one of said frame mounting members on its surface normal to said wall of said building, so that said U channels are rotatable relative to said frame, are opposite one another and inverted relative to one another, so that a protective board may removably slide into said U channels;
(d) a protective board having a predetermined shape and adapted to removably slide into said two U channels; and,
(e) securing means for temporarily securing said protective board and said U channels to a frame of a building to inhibit rotation of the U channels and protective board and to prevent removal of the protective board until unsecured.

12. The device of claim 1 wherein said U channels each contain an orifice at its attachment end for receiving an attachment component.

13. The device of claim 1 wherein said securing means includes an orifice at said securing end of each of said U channels and an anchoring member for passing through said orifice and for attachment to a frame.

14. The device of claim 13 wherein said orifice has a non-circular configuration and said anchoring member is a rotatable latch.

15. The device of claim 14 wherein said orifice has a keyhole configuration.

16. The device of claim 14 wherein said orifice is a cut out passing through at least two walls of said U channels.

17. The device of claim 11 wherein said protective board is a composite board which includes a first sheet of a structural plastic material and a second sheet of a glass fiber material.

18. The device of claim 17 wherein said composite board which includes a first sheet of a structural plastic material and a second sheet of a glass fiber material sandwiched between outer layers of fused polypropylene/glass fiber woven yarn.

19. The device of claim 11 wherein there are two sets of all elements (b) through (e)set forth in claim 11, and they are mounted adjacent one another as two sets of elements in said frame of said opening.

20. The device of claim 11 wherein said U channels are made of materials selected from the group consisting of plastic, metal and combinations thereof.
